(19) United States
(12) Patent Application Publication
(10) Pub. No.: US 2025/0378229 A1
(43) Pub. Date: Dec. 11, 2025

(54) DATA PROCESSING METHOD AND DATA PROCESSING APPARATUS

(71) Applicant: Fujitsu Limited, Kawasaki-shi (JP)

(72) Inventor: Noboru YONEOKA, Kawasaki (JP)

(73) Assignee: Fujitsu Limited, Kawasaki-shi (JP)

(21) Appl. No.: 19/309,663

(22) Filed: Aug. 26, 2025

Related U.S. Application Data
(63) Continuation of application No. PCT/JP2023/046568, filed on Dec. 26, 2023.

(30) Foreign Application Priority Data
Mar. 2, 2023 (JP) 2023-031775

(51) Int. Cl. G06F 30/20; G06F 111/04

(52) U.S. Cl. CPC G06F 30/20; G06F 2111/04

(57) ABSTRACT

A data processing apparatus includes a storage unit and a processing unit. The processing unit stores, in the storage unit, a solution found based on an evaluation function including a penalty function representing a constraint on a plurality of state variables and a constraint coefficient by which the penalty function is multiplied. The processing unit adjusts the constraint coefficient, based on the satisfaction status of the constraint for each of the plurality of solutions stored in the storage unit. The processing unit starts a search for a new solution based on the evaluation function including the adjusted constraint coefficient.

### CROSS-REFERENCE TO RELATED APPLICATIONS

This application is a continuation application of International Application PCT/JP2023/046568 filed on Dec. 26, 2023, which designated the U.S., which is based upon and claims the benefit of priority of the prior Japanese Patent Application No. 2023-031775, filed on Mar. 2, 2023, the entire contents of which are incorporated herein by reference.

### FIELD

The embodiments discussed herein relate to a data processing method and a data processing apparatus.

### BACKGROUND

An information processing apparatus may be used to solve a combinatorial optimization problem. The information processing apparatus searches combinations of values for the state variables included in an evaluation function to find, for example, a combination that minimizes the value of the evaluation function. In this case, the combination of the values for the state variables that minimizes the value of the evaluation function corresponds to a ground state or an optimal solution that is represented by a set of state variables. Techniques for obtaining an approximate solution to a combinatorial optimization problem within a practical time include a tabu search method, a simulated annealing (SA) method, and others.

In the case where the combinatorial optimization problem is a binary quadratic programming problem (BQP), the combinatorial optimization problem may be converted into an evaluation function indicating the energy of an Ising model, which is a model representing the behavior of spins of a magnetic material, and the problem may be solved using a quantum annealer or the like. For example, there has been proposed a system for solving the Lagrangian dual of a constrained quadratic binary programming problem using a quantum annealer. There has also been proposed a system for solving the Lagrangian dual of a binary polynomially constrained polynomial programming problem (BPCPPP) using a quantum annealer.

There has also been proposed a system for solving a minimum connected dominating set problem using quantum annealing.

Further, there has been proposed an optimization system that relaxes a BOP to an easy-to-solve problem called a semidefinite programming (SDP) problem and optimizes the BQP based on the solution of the SDP. See, for example, the following literatures.
U.S. Patent Application Publication No. 2016/0224515
International Publication Pamphlet No. WO 2017/145086
U.S. Patent Application Publication No. 2017/0286852
International Publication Pamphlet No. WO 2017/056368

### SUMMARY

In one aspect, there is provided a non-transitory computer-readable storage medium storing a computer program that causes a computer to perform a process including: storing, in a memory, a solution found based on an evaluation function, the evaluation function including a penalty function representing a constraint on a plurality of state variables and a constraint coefficient by which the penalty function is multiplied; and adjusting the constraint coefficient, based on a satisfaction status of the constraint for each of a plurality of solutions stored in the memory, and starting a search for a new solution based on the evaluation function including the adjusted constraint coefficient.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a data processing apparatus according to a first embodiment;

FIG. 2 illustrates an example of hardware of a data processing apparatus according to a second embodiment;

FIG. 3 illustrates an example of functions of the data processing apparatus;

FIG. 4 illustrates an example of data stored in a solution pool;

FIG. 5 illustrates an example of data stored in an output solution buffer;

FIG. 6 is a flowchart illustrating an example of a search process of the data processing apparatus;

FIG. 7 is a flowchart illustrating an example of updating the solution pool;

FIG. 8 is a flowchart illustrating an example of updating the output solution buffer;

FIG. 9 is a flowchart illustrating an example of adjusting a constraint coefficient (α);

FIG. 10 is a flowchart illustrating an example of adjusting a constraint coefficient (λₖ);

FIG. 11 is a flowchart illustrating another example of adjusting the constraint coefficient (α);

FIG. 12 is a flowchart illustrating another example of adjusting the constraint coefficient (λₖ); and

FIG. 13 illustrates an example of adjusting constraint coefficients.

### DESCRIPTION OF EMBODIMENTS

In an evaluation function for a BQP or the like, constraints on the state variables may be expressed as a penalty function. The penalty function adds the degree of constraint violations to the evaluation function on the basis of the values of the state variables.

For the evaluation a constraint function, coefficient that is a coefficient for weighting the penalty function may be used. In this case, it is not easy to appropriately determine the constraint coefficient. For example, if the constraint coefficient is too large, the search range for the solution is narrowed, and it is difficult to reach a better solution. On the other hand, if the constraint coefficient is too small, it is difficult to obtain a solution that satisfies the constraints.

Hereinafter, embodiments will be described with reference to the drawings.

### First Embodiment

A first embodiment will be described.

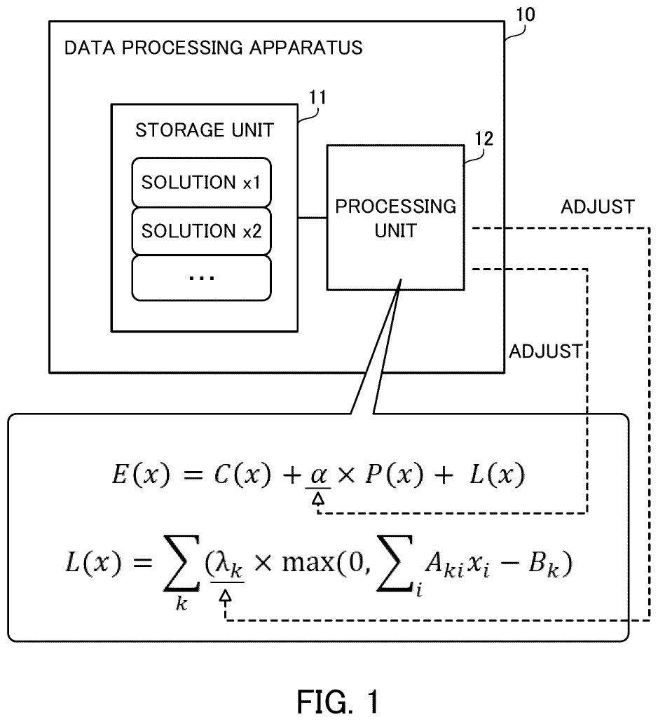

FIG. 1 illustrates a data processing apparatus according to the first embodiment.

A data processing apparatus 10 searches for a solution to a combinatorial optimization problem and outputs the found solution. The data processing apparatus 10 includes a storage unit 11 and a processing unit 12.

The storage unit 11 may be a volatile semiconductor memory such as a dynamic random access memory (DRAM) or a non-volatile storage such as a hard disk drive (HDD) or a flash memory. The storage unit 11 may include an electronic circuit such as a register. The processing unit 12 is, for example, a processor such as a central processing unit (CPU), a graphics processing unit (GPU), or a digital signal processor (DSP). However, the processing unit 12 may include a special-purpose electronic circuit such as an application specific integrated circuit (ASIC) or a field programmable gate array (FPGA). The processor executes a program stored in a memory (or the storage unit 11) such as a DRAM. A set of a plurality of processors may be referred to as a “multiprocessor” or simply as a “processor”.

A combinatorial optimization problem is formulated by an objective function representing the energy of an Ising model, and is replaced with, for example, a problem of minimizing the value of the objective function. The objective function includes a plurality of state variables. Each state variable is a binary variable that takes a value of 0 or 1. The state variables may be referred to as bits. A solution to the combinatorial optimization problem is represented by the values of the plurality of state variables.

For example, a solution that minimizes the value of the objective function represents a ground state of the Ising model and corresponds to an optimal solution to the combinatorial optimization problem. In this case, the combinatorial optimization problem is defined as Formula (1) using an Ising type objective function C(x).

$$minimize C ( x ) = - \frac{1}{2} {\sum }_{i , j} {W}_{i j} {x}_{i} {x}_{j} - {\sum }_{i} {b}_{i} {x}_{i} + c \qquad ( 1 )$$

A state vector x has a plurality of state variables as elements and represents a state of the Ising model. In the case of solving a problem that maximizes the energy, the signs of C(x) may be reversed. The problem represented by C(x) of Formula (1) is referred to as a quadratic unconstrained binary optimization (QUBO). C(x) may also be referred to as a cost function.

The first term on the right-hand side of Formula (1) is the sum of the products of the values of two state variables and a weight coefficient over all possible pairs of state variables selectable from all state variables without omission and repetitions. The subscripts i and j are the indices of state variables. Here, xᵢ denotes the i-th state variable, and xⱼ denotes the j-th state variable. Wᵢⱼ is a weight coefficient that indicates the weight between the i-th state variable and the j-th state variable, or the intensity of coupling strength. Note that Wᵢⱼ=Wⱼᵢ and Wᵢᵢ=0. In addition, the total number of state variables is denoted by n, and n is an integer of 2 or more.

The second term on the right-hand side of Formula (1) is the sum of the products of the bias and value of each of all the state variables. Here, bᵢ denotes the bias for the i-th state variable. c is a constant.

Here, constraints may be imposed on a plurality of state variables, as in a constrained BQP. In this case, the constraints are expressed by Formula (2) or Formula (3). Formula (2) represents a quadratic equality constraint. Formula (3) represents a linear inequality constraint.

$$P ( x ) = - \frac{1}{2} {\sum }_{i , j} {W}_{i j}^{′} {x}_{i} {x}_{j} - {\sum }_{i} {b}_{i}^{′} {x}_{i} + {c}^{′} \qquad ( 2 )$$

$${\sum }_{i = 1}^{n} {A}_{ki} {x}_{i} \leq {B}_{k} \qquad ( 3 )$$

P(x) of Formula (2) indicates the degree of violation of the equality constraint. W′ᵢⱼ and b′ᵢ are coefficients corresponding to Wᵢⱼ and bᵢ in Formula (1), respectively. Note that Wᵢⱼ=W′ⱼᵢ and W′ᵢᵢ=0. c′ is a constant. P(x) takes a positive value when the constraint is violated, and becomes 0 when the constraint is satisfied.

In Formula (3), k is an index of the inequality constraint, and k=1, 2, . . . , m. Here, m denotes the number of inequality constraints. Aₖᵢ and Bₖ are constants that are given based on the content of the inequality constraint.

In the case where the constraints of Formula (2) and Formula (3) are imposed, the combinatorial optimization problem may be expressed as a problem of minimizing the value of the evaluation function E(x) of Formula (4).

$$E ( x ) = C ( x ) + α \times P ( x ) + L ( x ) \qquad ( 4 )$$

Here, L(x) is expressed by Formula (5).

$$L ( x ) = {\sum }_{k} ( {λ}_{k} \times max ( 0 , {\sum }_{i} {A}_{ki} {x}_{i} - {B}_{k} ) ) \qquad ( 5 )$$

In the max operator, L(x) indicates an operation that takes the maximum value among the values in parentheses. L(x) takes a positive value when the inequality constraint k is violated, and becomes 0 when the inequality constraint k is satisfied. α is a constraint coefficient for the equality constraint. λₖ is a constraint coefficient for the inequality constraint k. For example, α and λₖ are integers of 1 or more. α and λₖ may be real numbers of 1 or more.

Here, P(x) is referred to as a penalty function. In addition, letting Lₖ(x)=λₖ×max(0, ΣᵢAxᵢ−Bₖ), L(x) is expressed as L(s)=ΣₖLₖ(x). Lₖ(x) is also referred to as a penalty function. L(x) is the sum (ΣₖLₖ(x)) of a plurality of penalty functions corresponding to a plurality of inequality constraints.

The evaluation function E(x) may include a plurality of penalty functions corresponding to a plurality of equality constraints. In the case where E(x) includes a plurality of penalty functions corresponding to a plurality of equality constraints, as many constraint coefficients α as the equality constraints are also included. Alternatively, m may be set to 1. Further, Formulae (4) and (5) indicate an example in which one equality constraint and m inequality constraints are included, but E(x) may include only either the penalty function corresponding to the equality constraint or the penalty function corresponding to the inequality constraint.

The data processing apparatus 10 searches for a better solution while transitioning the state by gradually changing the variable x based on E(x) with a heuristic method. The data processing apparatus 10 may use, for example, a greedy search method, a tabu search method, an SA method, or the like to search for a solution. The greedy search method is also referred to as a steepest descent method. In a problem of minimizing energy, the smaller the energy is, the better the solution is, and the larger the energy is, the worse the solution is.

Note that the values of the constraint coefficients α and λₖ affect the solving performance. For example, if α and λₖ are too large, P(x) and L(x) have strong influence in the solution search based on E(x). Although a solution obtained through the search is likely to have P(x)=0 and L(x)=0, i.e., to satisfy the constraints, but C(x) is not sufficiently small. On the other hand, if a and A are too small, P(x) and L(x) have weak influence in the solution search based on E(x). Although C(x) becomes small, P(x)>0 and L(x)>0 are obtained, which means that it is likely to violate the constraints. Therefore, the processing unit 12 adjusts the constraint coefficients as follows, based on a plurality of solutions obtained by a plurality of executions of the search.

First, the processing unit 12 stores a solution obtained by the search based on the evaluation function in the storage unit 11. The search for a solution may be executed by the processing unit 12 or may be executed by a search unit different from the processing unit 12. For example, the search unit may be implemented by a CPU, a GPU, a DSP, an ASIC, an FPGA, or the like included in the data processing apparatus 10 or an information processing apparatus that communicates with the data processing apparatus 10.

The search for a solution is performed a plurality of times while changing the search start state, for example. The search start state is a state serving as a starting point of the search. The search start state may be generated from solutions held in the storage unit 11. For example, the processing unit 12 acquires solutions x1, x2, . . . as a plurality of solutions and stores the solutions in the storage unit 11. The number of solutions held in the storage unit 11 is determined in advance.

Then, the processing unit 12 adjusts the constraint coefficients corresponding to the constraints included in the evaluation function, based on the satisfaction status of each constraint for each of the plurality of solutions stored in the storage unit 11. For example, in the case where none of the solutions x1, x2, . . . satisfy a certain constraint, the processing unit 12 increases the constraint coefficient corresponding to the constraint to strengthen the effect of the constraint. On the other hand, in the case where there a solution satisfying a certain constraint is included in the solutions x1, x2, . . . , the processing unit 12 decreases the constraint coefficient corresponding to the constraint to weaken the effect of the constraint. In the case where the number of solutions satisfying a certain constraint among the plurality of solutions held in the storage unit 11 is less than or equal to a predetermined number, the constraint coefficient corresponding to the constraint may be increased. In addition, in the case where the number of solutions satisfying a certain constraint among the plurality of solutions held in the storage unit 11 is greater than or equal to the predetermined number, the constraint coefficient corresponding to the constraint may be decreased.

Whether a solution satisfies a constraint is determined based on the value of the penalty function of the solution. For example, in the case of the evaluation function E(x), the equality constraint is satisfied when P(x)=0, and the equality constraint is not satisfied when P(x)>0. Similarly, the inequality constraint k is satisfied when Lₖ(x)=0, and the inequality constraint k is not satisfied when Lₖ(x)>0.

Here, in the case where the evaluation function includes a plurality of penalty functions corresponding to a plurality of constraints, as in the evaluation function E(x), the processing unit 12 adjusts the constraint coefficients corresponding to the constraints on the basis of the satisfaction status of each constraint for each of the solutions x1, x2, . . . . For example, the processing unit 12 adjusts the constraint coefficient λₖ based on the satisfaction status of the inequality constraint k for each of the solutions x1, x2, . . . .

In addition, the processing unit 12 does not always need to control the constraint coefficients α and λₖ individually for each of the equality constraint and inequality constraint. The processing unit 12 may also adjust at least one of the constraint coefficients α and λₖ based on the satisfaction status of the equality constraint and the inequality constraint. For example, in the case where none of the solutions x1, x2, . . . satisfy all the equality constraints and the inequality constraints, the processing unit 12 may increase, with a predetermined probability, at least one of the constraint coefficient xx corresponding to the equality constraint and the constraint coefficient λₖ corresponding to the inequality constraint k.

The processing unit 12 starts the search for a new solution based on the evaluation function including the adjusted constraint coefficients. Starting the search for a new solution may also be referred to as activating the search for a new solution. As described above, the search for a solution may be executed by the processing unit 12 or by a predetermined search unit. The search start state may be generated based on the solutions x1, x2, . . . stored in the storage unit 11. The processing unit 12 acquires a solution newly obtained by the search, and if the new solution is better than the worst solutions stored in the storage unit 11, replaces one of the worst solutions in the storage unit 11 with the new solution. In order to perform a comparison with the new solution in terms of energy, the processing unit 12 calculates in advance the energy of each solution stored in the storage unit 11 using the evaluation function with the latest constraint coefficients.

Separately from the solutions used for adjusting the constraint coefficients, the processing unit 12 also stores a solution to be finally output as a solution to the combinatorial optimization problem, in the storage unit 11. For example, the processing unit 12 uses predetermined fixed constraint coefficients α′ and λₖ′ instead of the constraint coefficients α and λₖ, respectively, calculates the energy E′ of each solution obtained through the search according to Formula (4), and preferentially stores a predetermined number of solutions with smaller energy E′ in the storage unit 11. For α′ and λₖ′, sufficiently large values are set with respect to C(x) in order to preferentially output constraint-satisfying solutions.

After performing the above-described search for a solution for a certain period of time or a certain number of times, the processing unit 12 preferentially outputs solutions with smaller energy E′ stored in the storage unit 11.

As described above, the data processing apparatus 10 stores, in the storage unit 11, solutions obtained by a search based on an evaluation function including a penalty function representing constraints on a plurality of state variables and a constraint coefficient, by which the penalty function are multiplied. The data processing apparatus 10 adjusts the constraint coefficient on the basis of the satisfaction status of the constraints for each of the plurality of solutions stored in the storage unit 11. The data processing apparatus 10 then starts the search for a new solution based on the evaluation function including the adjusted constraint coefficient. Thus, the data processing apparatus 10 is able to improve the solving performance in the solution search.

Note here that the influence of the constraints on the search is reflected in the satisfaction status of the constraints for each of the plurality of solutions. As described above, the solving performance deteriorates when the influence of the constraints is too strong or too weak.

By contrast, the data processing apparatus 10 dynamically adjusts the constraint coefficients on the basis of the satisfaction status of the constraints for each of the plurality of solutions, and thus the evaluation function is appropriately controlled such that the influence of the constraints on the search becomes moderate. Therefore, for example, compared to the case where the search is performed using fixed constraint coefficients, it becomes more likely to reach better solutions, which improves the solving performance.

For example, the data processing apparatus 10 is able to control the constraint coefficients so as to fluctuate around the boundary where the constraints are barely satisfied, and is able to achieve both a search in which the constraints are relaxed and a search in which the constraints are satisfied. As a result, it becomes more likely to reach better solutions in the solution search, which improves the solving performance.

### Second Embodiment

Next, a second embodiment will be described.

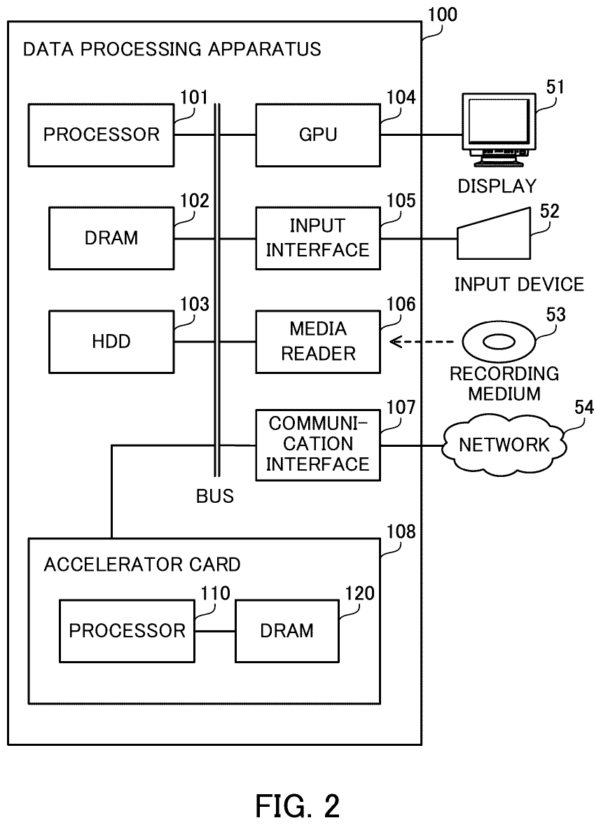

FIG. 2 illustrates an example of hardware of a data processing apparatus according to the second embodiment.

The data processing apparatus 100 searches for a solution to a constrained BQP using a greedy search method, a tabu search method, an SA method, or the like, and outputs the found solution. A constrained BQP is formulated by the evaluation function of Formula (4), and is replaced with a problem of minimizing the value of the evaluation function.

The second embodiment will describe an example in which one equality constraint and a plurality of inequality constraints are used. However, one or more equality constraints may be set, and one or more inequality constraints may be set. Alternatively, only either the equality constraint or the inequality constraint may be used in the problem to be solved.

The data processing apparatus 100 includes a processor 101, a DRAM 102, an HDD 103, a GPU 104, an input interface 105, a media reader 106, a communication interface 107, and an accelerator card 108. These units included in the data processing apparatus 100 are connected to a bus inside the data processing apparatus 100. The processor 101 corresponds to the processing unit 12 of the first embodiment. The DRAM 102 corresponds to the storage unit 11 of the first embodiment.

The processor 101 is an arithmetic device that executes program instructions. The processor 101 is, for example, a CPU. The processor 101 loads at least a part of a program or data stored in the HDD 103 into the DRAM 102 and executes the program. The processor 101 may include a plurality of processor cores. The data processing apparatus 100 may include a plurality of processors. Different processes among a plurality of processes performed by the data processing apparatus 100 may be performed by different processors. The processes that are described below may be performed in parallel using a plurality of processors or processor cores. A set of a plurality of processors may be referred to as a “multiprocessor” or simply as a “processor”. The processor may be referred to as “processor circuitry”.

The DRAM 102 is a volatile semiconductor memory that temporarily stores a program executed by the processor 101 and data used by the processor 101 for its operations. The data processing apparatus 100 may include a memory of a type other than DRAM, or may include a plurality of memories.

The HDD 103 is a non-volatile storage device that stores software programs such as an operating system (OS), middleware, and application software, and data. The data processing apparatus 100 may include another type of storage device such as a flash memory or a solid state drive (SSD), or may include a plurality of non-volatile storage devices.

The GPU 104 outputs images to a display 51 connected to the data processing apparatus 100 in accordance with instructions from the processor 101. The display 51 may be any type of display such as a cathode ray tube (CRT) display, a liquid crystal display (LCD), a plasma display, or an organic electro-luminescence (OEL) display.

The input interface 105 receives input signals from an input device 52 connected to the data processing apparatus 100 and outputs the input signals to the processor 101. As the input device 52, a pointing device such as a mouse, a touch panel, a touch pad, or a trackball, a keyboard, a remote controller, a button switch, or the like may be used. A plurality of types of input devices may be connected to the data processing apparatus 100.

The media reader 106 is a reading device that reads programs and data recorded on a recording medium 53. As the recording medium 53, for example, a magnetic disk, an optical disc, a magneto-optical (MO) disk, a semiconductor memory, or the like may be used. Magnetic disks include flexible disks (FDs) and HDDs. Optical discs include compact discs (CDs) and digital versatile discs (DVDs).

For example, the media reader 106 copies a program or data from the recording medium 53 to another recording medium such as the DRAM 102 or the HDD 103. The read program is executed by, for example, the processor 101. The recording medium 53 may be a portable recording medium, and may be used to distribute programs and data. The recording medium 53 and the HDD 103 may be referred to as computer-readable storage media.

The communication interface 107 is connected to a network 54 and communicates with other information processing apparatuses via the network 54. The communication interface 107 may be a wired communication interface connected to a wired communication device such as a switch or a router, or may be a wireless communication interface connected to a wireless communication device such as a base station or an access point.

The accelerator card 108 is a hardware accelerator that searches for a solution to a combinatorial optimization problem such as a BQP. The accelerator card 108 includes a processor 110 and a DRAM 120. The processor 110 searches for a solution using a greedy search method, a tabu search method, an SA method, or the like. The processor 110 is, for example, a GPU, a DSP, an ASIC, or an FPGA. The DRAM 120 stores data used for processing of the processor 110.

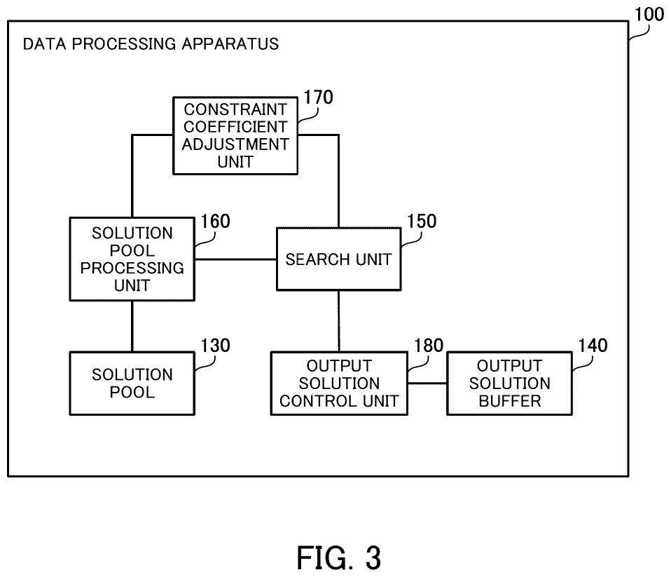

FIG. 3 illustrates an example of functions of the data processing apparatus.

The data processing apparatus 100 includes a solution pool 130, an output solution buffer 140, a search unit 150, a solution pool processing unit 160, a constraint coefficient adjustment unit 170, and an output solution control unit 180. The storage space of the DRAM 102 is used for the solution pool 130 and the output solution buffer 140. Alternatively, the storage space of the HDD 103 may be used for the solution pool 130 and the output solution buffer 140.

The solution pool processing unit 160, the constraint coefficient adjustment unit 170, and the output solution control unit 180 are implemented by the processor 101 executing a program stored in the DRAM 102. The search unit 150 is implemented by the processor 110. Note that the search unit 150 may be implemented by the processor 101 executing a program stored in the DRAM 102.

The solution pool 130 stores a predetermined number of solutions found by the search unit 150. The solutions stored in the solution pool 130 are used for adjusting the constraint coefficients α and λₖ included in the evaluation function E(x) of Formula (4). The quality of each solution held in the solution pool 130 is determined based on the energy E calculated with Formulae (4) and (5) including the constraint coefficients α and λₖ.

The output solution buffer 140 stores a predetermined number of solutions found by the search unit 150. The solutions stored in the output solution buffer 140 are candidates for the final solution to the constrained BQP. The quality of each solution held in the output solution buffer 140 is determined based on the energy E′ calculated with Formulae (4) and (5) using predetermined fixed constraint coefficients α′ and λₖ′ instead of the constraint coefficients α and λₖ. The solutions held in the output solution buffer 140 are solutions that are candidates for the final output for the problem to be solved. Therefore, the energy E′ may be referred to as an output evaluation energy.

In an initial stage at which the search is not yet executed, a predetermined number of solutions created in advance are held in the solution pool 130 and the output solution buffer 140. The number of solutions held in the output solution buffer 140 may be the same as or different from the number of solutions held in the solution pool 130.

The search unit 150 searches for a solution based on the evaluation function E(x) of Formula (4) including the constraint coefficients α and λₖ. For example, a greedy search method, a tabu search method, an SA method, or the like is used in the solution search performed by the search unit 150. The constraint coefficients α and λₖ are input to the search unit 150 by the constraint coefficient adjustment unit 170. The search unit 150 outputs the found solution to the solution pool processing unit 160 and the output solution control unit 180.

The solution pool processing unit 160 acquires a new solution found by the search unit 150, and if the new solution is better than the worst solution in the solution pool 130, replaces the worst solution in the solution pool 130 with the new solution. As described above, the solution pool processing unit 160 determines the quality of each solution held in the solution pool 130, based on the energy E calculated with Formulae (4) and (5) including the constraint coefficients α and λₖ.

In addition, the solution pool processing unit 160 creates a search start state to be used by the search unit 150 for the next execution of the search, based on the solutions held in the solution pool 130, and inputs the search start state to the search unit 150. For example, a method such as Path Relinking may be used to create the search start state. Path Relinking is described in the following literature.

Y. Wang and three others, “Path relinking for unconstrained binary quadratic programming”, European Journal of Operational Research, volume 223, issue 3, Dec. 16, 2012, pp. 595-604

The constraint coefficient adjustment unit 170 adjusts the constraint coefficients α and λₖ according to the satisfaction status of the equality constraint and the inequality constraints for each of the plurality of solutions held in the solution pool 130. The constraint coefficient adjustment unit 170 inputs the adjusted α and λₖ to the search unit 150 and causes the search unit 150 to start the search for a new solution.

The output solution control unit 180 acquires the new solution found by the search unit 150, and if the new solution is better than any of the solutions stored in the output solution buffer 140, replaces the worst solution in the output solution buffer 140 with the new solution. As described above, the output solution control unit 180 determines the quality of each solution in the output solution buffer 140, based on the energy E′ calculated with Formulae (4) and (5) including the constraint coefficients α′ and λₖ′.

After the search unit 150 executes the search for a certain period of time or a certain number of times, the output solution control unit 180 preferentially outputs solutions with smaller energy E′ among the solutions included in the output solution buffer 140. The output solution control unit 180 may output the best solution stored in the output solution buffer 140, or may output some or all of the solutions stored in the output solution buffer 140. For example, the output solution control unit 180 may cause the display 51 to display information on the solutions, or may transmit the information on the solutions to another computer via the network 54.

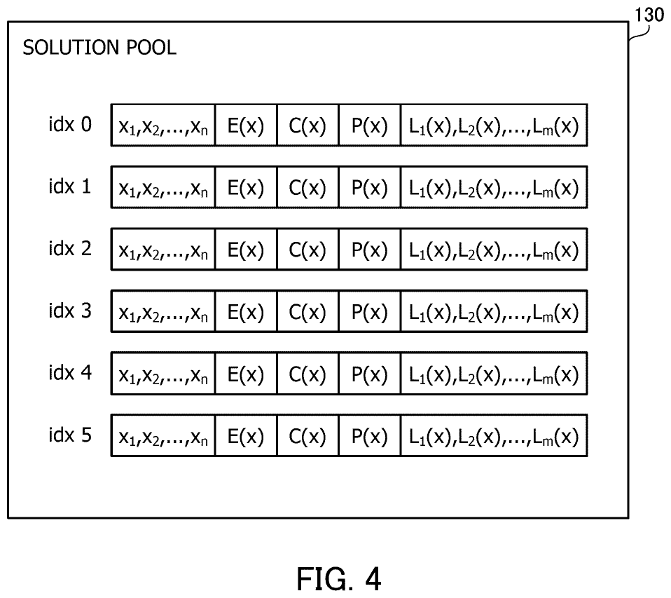

FIG. 4 illustrates an example of data stored in a solution pool.

As an example, the solution pool 130 holds records corresponding to six solutions. Six indices (idx) “0” to “5” identify the records in the solution pool 130. A smaller index identifies a record corresponding to a solution with smaller energy E.

One record includes a solution represented as a state vector x=(x₁, x₂, . . . , xₙ), a value of the energy E(x) corresponding to the solution, a value of the cost function C(x), a value of the penalty function P(x) of the equality constraint, and values of the penalty functions L₁(x), L₂(2), . . . , and Lₘ(x) of the inequality constraints.

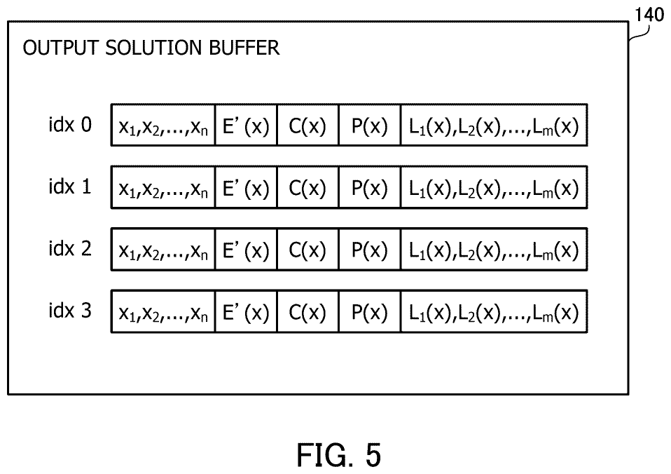

FIG. 5 illustrates an example of data stored in the output solution buffer.

As an example, the output solution buffer 140 holds records corresponding to four solutions. Four indices (idx) “0” to “3” identify the records in the output solution buffer 140. A smaller index identifies a record corresponding to a solution with smaller energy E′.

One record includes a solution represented as a state vector x=(x₁, x₂, . . . xₙ), a value of the energy E′(x) corresponding to the solution, a value of the cost function C(x), a value of the penalty function P(x) of the equality constraint, and values of the penalty functions L₁(x), L₂(2), . . . and Lₘ(x) of the inequality constraints. However, the records in the output solution buffer 140 do not need to include C(x), P(x), L₁(x), L₂(2), . . . , or Lₘ(x).

Next, a processing procedure of the data processing apparatus 100 will be described.

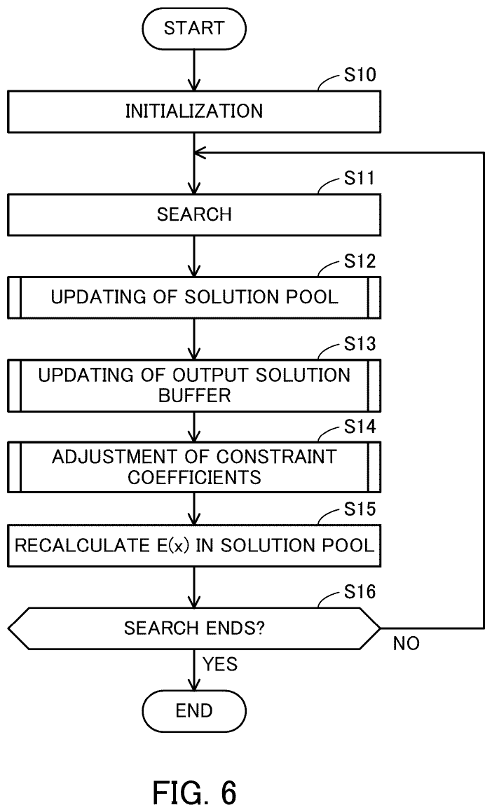

FIG. 6 is a flowchart illustrating an example of a search process of the data processing apparatus.

(S10) The search unit 150 performs initialization. This initialization, which is performed by the search unit 150, involves setting the evaluation function E(x) corresponding to a BOP to be solved, setting the values of various parameters used for the search (for example, temperature values in the SA method), setting an initial search start state, and others. The evaluation function E(x) in step S10 includes the initial values of the constraint coefficients α and λₖ. In addition, in the initialization, the solution pool processing unit 160 sets a predetermined number of initial solutions in the solution pool 130. Further, in the initialization, the output solution control unit 180 sets a predetermined number of initial solutions in the output solution buffer 140.

(S11) The search unit 150 searches for a solution, based on the evaluation function E(x). Here, the search start state is created from a plurality of solutions stored in the solution pool 130 by the solution pool processing unit 160 and is input to the search unit 150. When the current search ends, the search unit 150 outputs the solution obtained through the current search to the solution pool processing unit 160 and the output solution control unit 180. The search unit 150 may output a plurality of solutions obtained through the current search to the solution pool processing unit 160 and the output solution control unit 180.

(S12) The solution pool processing unit 160 updates the solution pool 130. The details of the updating of the solution pool 130 will be described later.

(S13) The output solution control unit 180 updates the output solution buffer 140. The details of the updating of the output solution buffer 140 will be described later.

(S14) The constraint coefficient adjustment unit 170 adjusts the constraint coefficients α and λₖ included in E(x) based on the satisfaction status of the constraints for each of the plurality of solutions held in the solution pool 130, and outputs the adjusted α and λₖ to the search unit 150. The details of the adjustment of the constraint coefficients will be described later.

(S15) The solution pool processing unit 160 recalculates E(x) of each solution held in the solution pool 130 using Formulae (4) and (5) using the constraint coefficients α and λₖ adjusted in step S14, and stores the recalculated E(x) in the solution pool 130.

(S16) The search unit 150 determines whether to end the search. If the end of the search is determined, the search process ends. If the end of the search is not determined, the process proceeds to step S11. For example, the search unit 150 determines to end the search when the search of steps S11 to S15 has been executed for a certain period of time or a certain number of times. Upon receiving information indicating that the search has been executed for a certain period of time or a certain number of times, the search unit 150 may determine to end the search. When the search ends, the output solution control unit 180 outputs the solutions held in the output solution buffer 140.

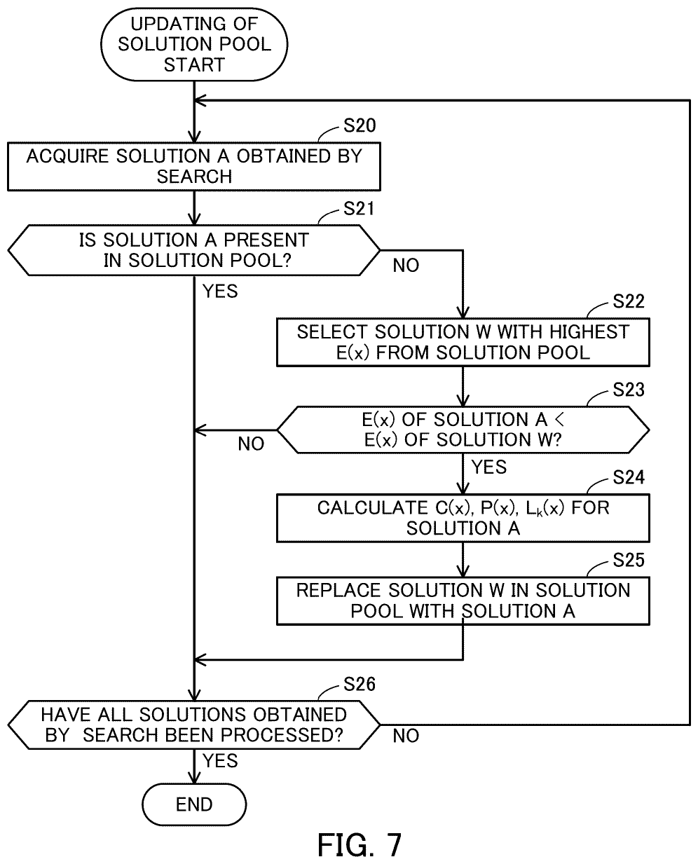

FIG. 7 is a flowchart illustrating an example of updating the solution pool.

The updating of the solution pool 130 corresponds to step S12.

(S20) The solution pool processing unit 160 acquires a solution A obtained through the current search from the search unit 150.

(S21) The solution pool processing unit 160 determines whether the solution A is present in the solution pool 130. If the solution A is present in the solution pool 130, the process proceeds to step S26. If the solution A is not present in the solution pool 130, the process proceeds to step S22.

(S22) The solution pool processing unit 160 selects a solution W with the highest E(x) from the solution pool 130.

(S23) The solution pool processing unit 160 determines whether E(x) of the solution A is smaller than E(x) of the solution W. If E(x) of the solution A is smaller than E(x) of the solution W, the process proceeds to step S24. If E(x) of the solution A is greater than or equal to E(x) of the solution W, the process proceeds to step S26.

(S24) The solution pool processing unit 160 calculates C(x), P(x), and Lₖ(x) for the solution A. The calculation of C(x), P(x), and Lₖ(x) in step S24 is performed using the current values of the constraint coefficients α and Ak.

(S25) The solution pool processing unit 160 replaces the solution W in the solution pool 130 with the solution A.

(S26) The solution pool processing unit 160 determines whether all solutions obtained through the current search by the search unit 150 have been processed. If all the solutions obtained through the current search have been processed, the updating of the solution pool 130 ends. If any of the solutions obtained through the current search has not been processed, the process proceeds to step S20. In step S20, a next new solution is acquired as the solution A.

In this way, the solution pool processing unit 160 appropriately replaces the worst solution regarding E(x) in the solution pool 130 with a solution obtained through the search, without allowing duplicates.

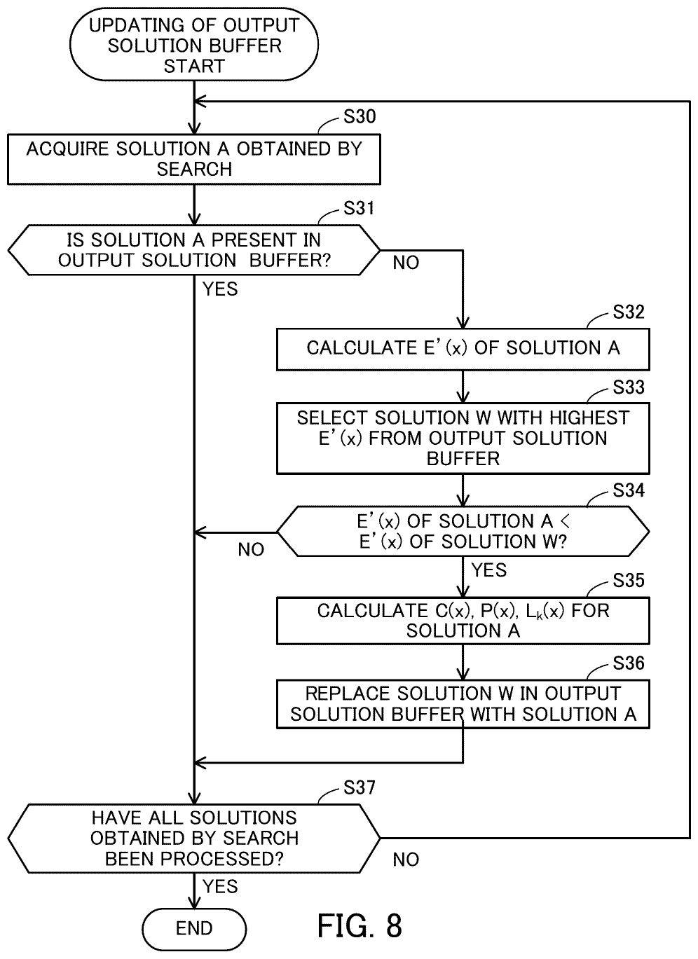

FIG. 8 is a flowchart illustrating an example of updating the output solution buffer.

The updating of the output solution buffer 140 corresponds to step S13.

(S30) The output solution control unit 180 acquires a solution A obtained through the current search from the search unit 150.

(S31) The output solution control unit 180 determines whether the solution A is present in the output solution buffer 140. If the solution A is present in the output solution buffer 140, the process proceeds to step S37. If the solution A is not present in the output solution buffer 140, the process proceeds to step S32.

(S32) The output solution control unit 180 calculates the energy E′(x) of the solution A. E′(x) is calculated by substituting α=α′, λₖ=λₖ′, and the value of each state variable of the solution A into Formula (5).

(S33) The output solution control unit 180 selects the solution W with the highest E′(x) from the output solution buffer 140.

(S34) The output solution control unit 180 determines whether E′(x) of the solution A is smaller than E′(x) of the solution W. If E′(x) of the solution A is smaller than E′(x) of the solution W, the process proceeds to step S35. If E′(x) of the solution A is greater than or equal to E′(x) of the solution W, the process proceeds to step S37.

(S35) The output solution control unit 180 calculates C(x), P(x), and Lₖ(x) of the solution A. The calculation of C(x), P(x), and Lₖ(x) in step S35 is performed using the values of the constraint coefficients α′ and λₖ′.

(S36) The output solution control unit 180 replaces the solution W in the output solution buffer 140 with the solution A.

(S37) The output solution control unit 180 determines whether all solutions obtained through the current search by the search unit 150 have been processed. If all the solutions obtained through the current search have been processed, the updating of the output solution buffer 140 ends. If any of the solutions obtained through the current search has not been processed, the process proceeds to step S30. In step S30, a next new solution is acquired as the solution A.

In this way, the output solution control unit 180 appropriately replaces the worst solution regarding E′(x) in the output solution buffer 140 with a solution obtained through the search, without allowing duplicates.

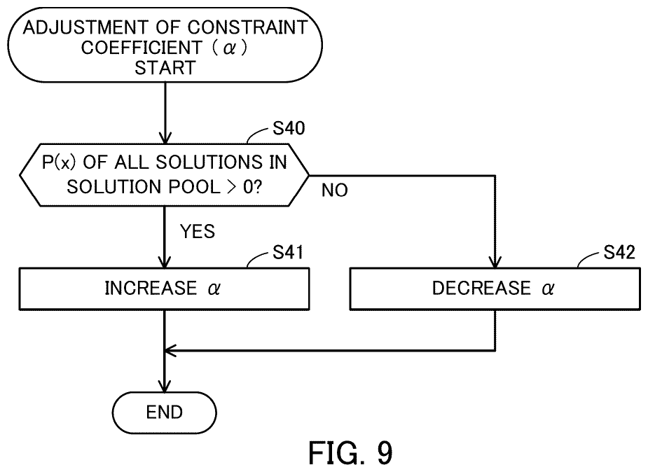

FIG. 9 is a flowchart illustrating an example of adjusting the constraint coefficient (α).

The adjustment of the constraint coefficient (α) corresponds to step S14.

(S40) The constraint coefficient adjustment unit 170 determines whether P(x) of all solutions in the solution pool 130 is positive. If P(x) of all the solutions in the solution pool 130 is positive, the process proceeds to step S41. If P(x) of at least one solution in the solution pool 130 is 0, the process proceeds to step S42. Here, P(x) being positive (P(x)>0) indicates that the equality constraint is not satisfied. P(x) being 0 (P(x)=0) indicates that the equality constraint is satisfied.

(S41) The constraint coefficient adjustment unit 170 increases α. Then, the adjustment of the constraint coefficient (α) ends.

(S42) The constraint coefficient adjustment unit 170 decreases α. Then, the adjustment of the constraint coefficient (α) ends.

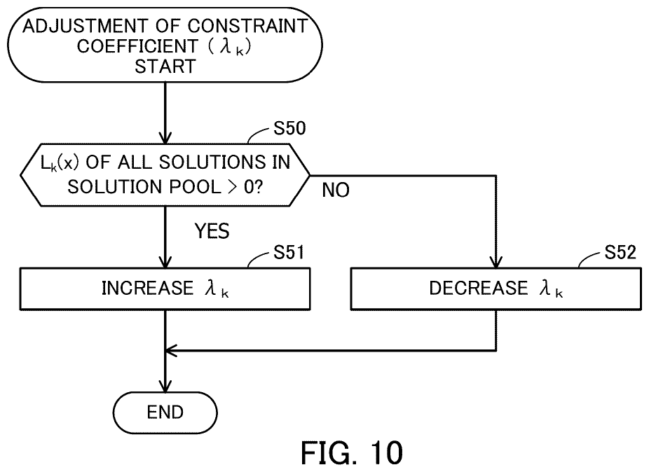

FIG. 10 is a flowchart illustrating an example of adjusting the constraint coefficient (Ak).

The adjustment of the constraint coefficient (Ak) corresponds to step S14. The following procedure is repeated for each inequality constraint, that is, for each k, or performed in parallel.

(S50) The constraint coefficient adjustment unit 170 determines whether Lₖ(x) of all solutions in the solution pool 130 is positive. If Lₖ(x) of all the solutions in the solution pool 130 is positive, the process proceeds to step S51. If Lₖ(x) of at least one solution in the solution pool 130 is 0, the process proceeds to step S52. Here, Lₖ(x) being positive (Lₖ(x)>0) indicates that the inequality constraint k is not satisfied. Lₖ(x) being 0 (Lₖ(x)=0) indicates that the inequality constraint k is satisfied.

(S51) The constraint coefficient adjustment unit 170 increases λₖ. Then, the adjustment of the constraint coefficient (λₖ) ends.

(S52) The constraint coefficient adjustment unit 170 decreases λₖ. Then, the adjustment of the constraint coefficient (λₖ) ends.

In step S14, the constraint coefficient adjustment unit 170 adjusts the constraint coefficients α and λk, as illustrated in FIGS. 9 and 10. The adjustment of the constraint coefficients may be performed in any order or may be performed in parallel.

The constraint coefficient adjustment unit 170 may adjust the constraint coefficient α according to the following procedure instead of the procedure of FIG. 9.

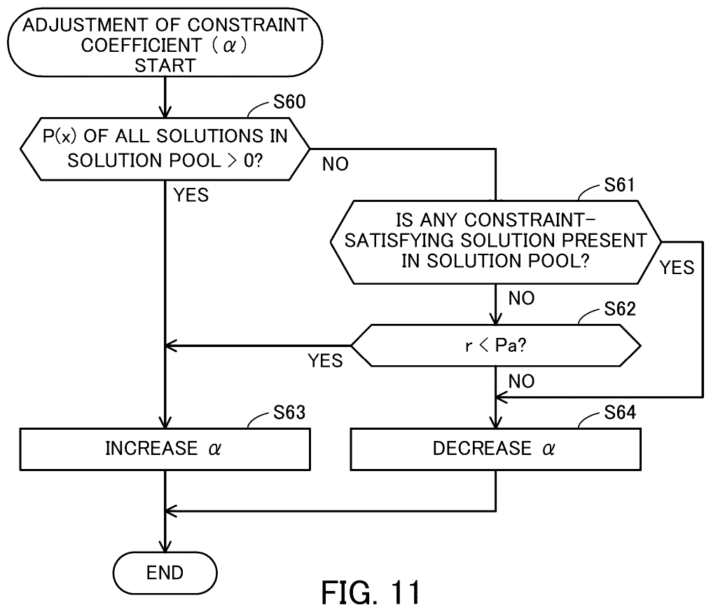

FIG. 11 flowchart illustrating another example of adjusting the constraint coefficient (α).

The adjustment of the constraint coefficient (α) corresponds to step S14.

(S60) The constraint coefficient adjustment unit 170 determines whether P(x) of all solutions in the solution pool 130 is positive. If P(x) of all solutions in the solution pool 130 is positive, the process proceeds to step S63. If P(x) of at least one solution in the solution pool 130 is 0, the process proceeds to step S61.

(S61) The constraint coefficient adjustment unit 170 determines whether there is any constraint-satisfying solution in the solution pool 130. If no constraint-satisfying solution is present, the process proceeds to step S62. If a constraint-satisfying solution is present, the process proceeds to step S64. Here, the constraint-satisfying solution indicates a solution that satisfies all constraints, i.e., is a solution that satisfies P(x)=0 and L(x)=ΣₖLₖ(x)=0 in the example of Formula (4).

(S62) The constraint coefficient adjustment unit 170 determines whether r<Pa is satisfied. If r<Pa, the process proceeds to step S63. If r<Pa is not satisfied, the process proceeds to step S64. Here, r is, for example, a random number of 0 or more and less than 1 generated by the constraint coefficient adjustment unit 170. In one example, Pa=0.1. However, Pa may be set to another value.

(S63) The constraint coefficient adjustment unit 170 increases α. Then, the adjustment of the constraint coefficient (α) ends.

(S64) The constraint coefficient adjustment unit 170 decreases α. Then, the adjustment of the constraint coefficient (α) ends.

The constraint coefficient adjustment unit 170 may adjust the constraint coefficient λₖ according to the following procedure instead of the procedure of FIG. 10.

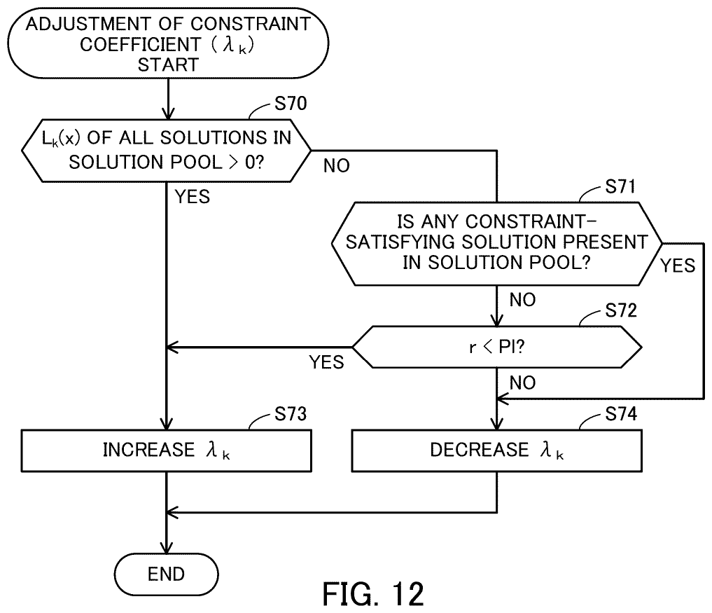

FIG. 12 is a flowchart illustrating another example of adjusting the constraint coefficient (λₖ).

The adjustment of the constraint coefficient (λₖ) corresponds to step S14. The following procedure is repeated for each inequality constraint, that is, for each k, or performed in parallel.

(S70) The constraint coefficient adjustment unit 170 determines whether Lₖ(x) of all the solutions in the solution pool 130 is positive. If Lₖ(x) of all the solutions in the solution pool 130 is positive, the process proceeds to step S73. If Lₖ(x) of at least one solution in the solution pool 130 is 0, the process proceeds to step S71.

(S71) The constraint coefficient adjustment unit 170 determines whether there is any constraint-satisfying solution in the solution pool 130. If no constraint-satisfying solution is present, the process proceeds to step S72. If a constraint-satisfying solution is present, the process proceeds to step S74.

(S72) The constraint coefficient adjustment unit 170 determines whether r<Pl is satisfied. If r<Pl, the process proceeds to step S73. If r<Pl is not satisfied, the process proceeds to step S74. Here, r is, for example, a random number of 0 or more and less than 1 generated by the constraint coefficient adjustment unit 170. In one example, Pl=0.1. However, Pl may be set to another value, and may be set to a value different from Pa.

(S73) The constraint coefficient adjustment unit 170 increases λₖ. Then, the adjustment of the constraint coefficient (λₖ) ends.

(S74) The constraint coefficient adjustment unit 170 decreases λₖ. Then, the adjustment of the constraint coefficient (λₖ) ends.

Here, a specific method of increasing for decreasing constraint coefficients by the constraint coefficient adjustment unit 170 will be described. For example, the constraint coefficient adjustment unit 170 increases or decreases the constraint coefficient α of the equality constraint as follows. In the following description, α1 denotes a current constraint coefficient. In addition, α2 denotes the next constraint coefficient (adjusted constraint coefficient).

In the case where the constraint coefficient adjustment unit 170 increases the constraint coefficient α, the constraint coefficient adjustment unit 170 determines α2 using Formula (6).

$$α2 = ceil ( max ( 1. , {d}_{0} \times α 1 ) ) \qquad ( 6 )$$

In the case where the constraint coefficient adjustment unit 170 decreases the constraint coefficient α, the constraint coefficient adjustment unit 170 determines α2 using Formula (7).

$$α2 = floor ( max ( 1. , {d}_{1} \times α 1 ) ) \qquad ( 7 )$$

For example, an increase rate d₀ and a decrease rate d₁ are fixed values given in advance by the user. d₀ is a value satisfying 1.0<d₀. d₁ is a value satisfying 0<d₁<1.0. In one example, d₀=1.2 and d₁=0.9. max(a, b) is a function that selects the larger of a and b. Specifically, max(1.0, x) is a function that outputs 1.0 if x is smaller than 1.0, and outputs x if x is greater than or equal to 1.0. ceil( ) is a function that rounds a number up to the nearest integer. floor( ) is a function that rounds a number down to the nearest integer.

In addition, the constraint coefficient adjustment unit 170 increases or decreases the constraint coefficient λₖ of the inequality constraint k as follows. In the following description, λ1ₖ denotes the current constraint coefficient. In addition, λ2ₖ denotes the next constraint coefficient (adjusted constraint coefficient).

In the case where the constraint coefficient adjustment unit 170 increases the constraint coefficient λₖ, the constraint coefficient adjustment unit 170 determines λ2ₖ using Formula (8).

$$λ {2}_{k} = ceil ( max ( 1 \text{.0} , {d}_{0} \times λ {1}_{k} ) ) \qquad ( 8 )$$

In the case the constraint coefficient adjustment unit 170 decreases the constraint coefficient λₖ, the constraint coefficient adjustment unit 170 determines λ2ₖ using Formula (9).

$$λ {2}_{k} = floor ( max ( 1. , {d}_{1} \times {λ1}_{k} ) ) \qquad ( 9 )$$

The meanings of the ceil, floor, and max functions are the same as in the case of the constraint coefficient α. Also, for d₀ and d₁ in Formulae (8) and (9), fixed values are preset by the user as in the case of the equality constraint α. In addition, each of d₀ and d₁ may be the same value in a plurality of equality constraints and a plurality of inequality constraints, or may differ depending on the constraint.

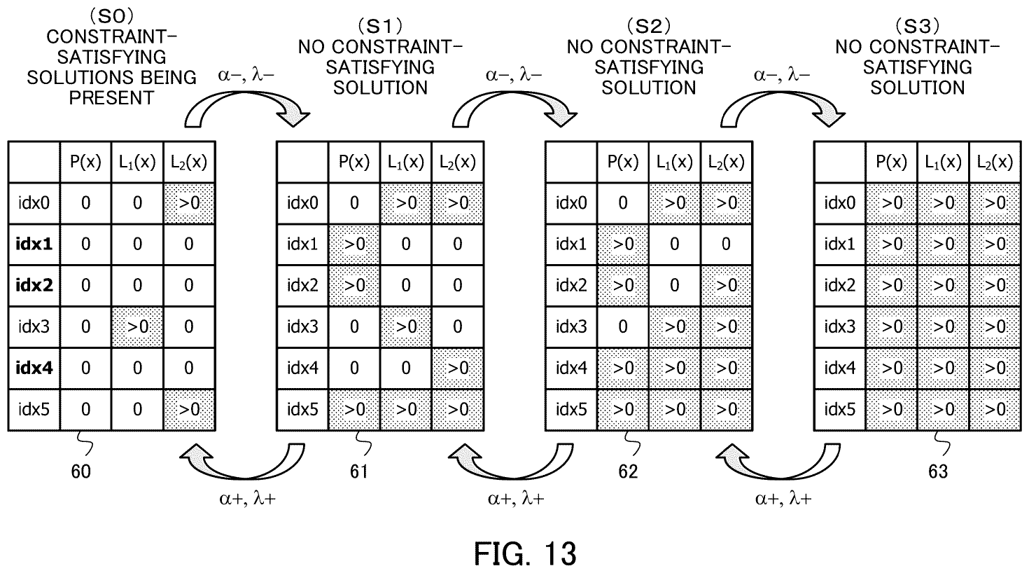

FIG. 13 illustrates an example of adjusting constraint coefficients.

Here, as an example, it is assumed that the number of equality constraints is 1 and the number m of inequality constraints is m=2. In this case, Formula (5) includes two penalty functions L₁(x) and L₂(x) corresponding to two inequality constraints.

Tables 60, 61, 62, and 63 represent examples of the constraint satisfaction status of P(x), L₁(x), and L₂(x) for six solutions in the solution pool 130 in steps S0, S1, S2, and S3, respectively. A notation “0” in P(x), L₁(x), and L₂(x) indicates that the corresponding constraint is satisfied. On the other hand, a notation “>0” in P(x), L₁(x), and L₂(x) indicates that the corresponding constraint is not satisfied. Step S0 represents a case where constraint-satisfying solutions are present. Steps S1 to S3 represent cases where no constraint-satisfying solution is present. A notation “α-” indicates that α is decreased. A notation “λ-” indicates that λₖ is decreased. A notation “α+” indicates that α is increased. A notation “λ+” indicates that λₖ is increased.

In the adjustment of constraint coefficients in FIGS. 9 and 10, the constraint coefficients are adjusted independently for each constraint, which enables a search in the vicinity of the constraint satisfaction boundary for each constraint. As a result, the constraints are relaxed and tightened repeatedly, which improves the solving performance. However, with only the independent control illustrated in FIGS. 9 and 10, for example, there may be a case where the values of α and λₖ that yield a constraint-satisfying solution as in step S0 are not reached even when steps S2 and S3 are repeated starting from step S1 over time.

Therefore, the constraint coefficient adjustment unit 170 may use the procedures of FIGS. 11 and 12, instead of the procedures of FIGS. 9 and 10, to adjust the constraint coefficients. That is, the constraint coefficient adjustment unit 170 may increase α with the probability Pa in the case where there is no solution (constraint-satisfying solution) satisfying P(x)=0 and L(x)=0 in the solution pool 130. In addition, in the case where there is no solution satisfying P(x)=0 and L(x)=0 in the solution pool 130, the constraint coefficient adjustment unit 170 may increase Ak with the probability P1. In this way, the constraint coefficient adjustment unit 170 changes (increases) a and Ak so as to probabilistically shift from step S2 to step S1 and from step S1 to step S0, thereby obtaining a solution that satisfies all constraints, that is, a constraint-satisfying solution.

As described above, the data processing apparatus 100 according to the second embodiment automatically and appropriately controls the constraint coefficients of the equality constraint and the inequality constraints in a BQP, thereby achieving high solving performance while reducing the user's labor.

It may also be said that the data processing apparatus 100 performs the following process.

The processor 101 stores, in the solution pool 130, solutions obtained based on an evaluation function, which includes a penalty function representing constraints on a plurality of state variables and a constraint coefficient by which the penalty function is multiplied. The processor 101 adjusts the constraint coefficient based on the satisfaction status of constraints for each of the plurality of solutions stored in the solution pool 130, and starts a search for a new solution based on the evaluation function including the adjusted constraint coefficient.

As a result, the data processing apparatus 100 is able to improve the solving performance in searching for a solution based on the evaluation function. The constraints are equality constraints or inequality constraints, for example. As described above, the solution pool 130 is implemented using a storage space such as the DRAM 102 or the HDD 103. The DRAM 102 and the HDD 103 are examples of the storage unit 11 of the first embodiment.

The evaluation function may include a plurality of penalty functions corresponding to a plurality of constraints. In this case, the processor 101 individually adjusts the constraint coefficient corresponding to each constraint, based on the satisfaction status of the constraint for each of the plurality of solutions.

In this way, the processor 101 is able to improve the solving performance by adjusting the constraint coefficient for each constraint independently. The plurality of constraints include, for example, equality constraints, inequality constraints, or both.

In the adjustment of the constraint coefficients, the processor 101 increases the constraint coefficient corresponding to a constraint in the case where a predetermined number of solutions satisfying the constraint are not included in the plurality of solutions in the solution pool 130, and decreases the constraint coefficient corresponding to the constraint in the case where the predetermined number of solutions satisfying the constraint are included in the plurality of solutions. Increasing a constraint coefficient means increasing the value of the constraint coefficient. Similarly, decreasing a constraint coefficient means decreasing the value of the constraint coefficient.

By performing the adjustment to increase or decrease the constraint coefficient for a constraint in this manner, it becomes possible to perform a search in t vicinity of the constraint satisfaction boundary of the constraint. As a result, relaxation and tightening of the constraint are repeated, which improves the solving performance.

In the case where the plurality of constraints include both equality and inequality constraints, the processor 101 may adjust the constraint coefficients as follows. The processor 101 may increase at least one of the first constraint coefficient corresponding to the equality constraint and the second constraint coefficient corresponding to the inequality constraint with a predetermined probability, in the case where there is no solution satisfying all equality and inequality constraints among the plurality of solutions.

As a result, the data processing apparatus 100 is able to increase the likelihood of obtaining a constraint-satisfying solution, and thus to improve the solving performance.

Furthermore, after adjusting the constraint coefficients, the processor 101 calculates the energy E(x) corresponding to each of the plurality of solutions stored in the solution pool 130, based on the evaluation function including the adjusted constraint coefficients. The processor 101 replaces the worst solution among the plurality of solutions stored in the solution pool 130 with a first solution newly obtained by the search, depending on a comparison between the first energy calculated for the first solution using the evaluation function and the energy corresponding to the worst solution among the plurality of solutions.

Thus, the data processing apparatus 100 is able to gradually improve solutions in the solution pool 130. For example, it is highly likely that a better solution exists in the vicinity of a good solution. Therefore, the processor 101 may generate a search start state to be used for the next execution of the search, using a predetermined method such as Path Relinking described above, based on the plurality of solutions in the solution pool 130. This increases the likelihood of reaching an even better solution in the new execution of the search.

Separately from the plurality of solutions stored in the solution pool 130, the processor 101 also stores one or more solutions in the output solution buffer 140. The one or more solutions held in the output solution buffer 140 are candidates for the final output for the problem to be solved. Further, the processor 101 also stores, in the output solution buffer 140, the output evaluation energy E′(x) corresponding to each of the one or more solutions, which are calculated using the evaluation function in which the constraint coefficients are fixed values, which remain unchanged for each execution of the search. Then, the processor 101 compares the first output evaluation energy calculated using the evaluation function in which the constraint coefficients are set to fixed values with respect to the first solution newly obtained by the search with the output evaluation energy corresponding to the worst solution among the one or more solutions. The processor 101 replaces the worst solution among the one or more solutions stored in the output solution buffer 140 with the first solution depending on the comparison. When the process of repeating the adjustment of the constraint coefficients and the search ends, the processor 101 outputs at least one of the one or more solutions stored in the output solution buffer 140.

Thus, the data processing apparatus 100 is able to control which solutions are held in the output solution buffer 140, according to certain criteria determined by the constraint coefficients having fixed values, and is thus able to appropriately control solutions to be finally output. For example, as described above, in order to preferentially output constraint-satisfying solutions, the constraint coefficients (for example, o′ or A′k) are set to sufficiently large fixed values with respect to C(x). For example, the processor 101 is able to preferentially output solutions with better output evaluation energies among the one or more solutions stored in the output solution buffer 140.

The information processing of the first embodiment may be implemented by causing the processing unit 12 to execute a program. The information processing of the second embodiment may be implemented by causing the processor 101 to execute a program. Such a program may be recorded on the computer-readable recording medium 53.

For example, the program may be distributed by distributing the recording medium 53 on which the program is recorded. The program may be stored in another computer and distributed via a network. For example, the computer may store (install) the program recorded on the recording medium 53 or the program received from another computer in a storage device such as the DRAM 102 or the HDD 103, read the program from the storage device, and execute the program.

In one aspect, it is possible to improve the solving performance.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to perform a process comprising:
storing, in a memory, a solution found based on an evaluation function, the evaluation function including a penalty function representing a constraint on a plurality of state variables and a constraint coefficient by which the penalty function is multiplied; and
adjusting the constraint coefficient, based on a satisfaction status of the constraint for each of a plurality of solutions stored in the memory, and starting a search for a new solution based on the evaluation function including the adjusted constraint coefficient.

2. The non-transitory computer-readable storage medium according to claim 1, wherein
the constraint is provided in plurality, the penalty function is provided in plurality, and the evaluation function includes the plurality of penalty functions corresponding to the plurality of constraints, and
the process further includes adjusting, for each constraint of the plurality of constraints, a constraint coefficient corresponding to said each constraint, based on a satisfaction status of said each constraint for each of the plurality of solutions.

3. The non-transitory computer-readable storage medium according to claim 2, wherein the plurality of constraints include an equality constraint, an inequality constraint, or both the equality constraint and the inequality constraint.

4. The non-transitory computer-readable storage medium according to claim 2, wherein
the plurality of constraints include an equality constraint and an inequality constraint, and
the process further includes increasing, with a predetermined probability, at least one of a first constraint coefficient corresponding to the equality constraint or a second constraint coefficient corresponding to the inequality constraint, upon determining that no solution satisfying all the equality constraint and the inequality constraint is included in the plurality of solutions.

5. The non-transitory computer-readable storage medium according to claim 1, wherein the constraint is an equality constraint or an inequality constraint.

6. The non-transitory computer-readable storage medium according to claim 1, wherein the process further includes
increasing the constraint coefficient corresponding to the constraint upon determining that a predetermined number of solutions satisfying the constraint are not included in the plurality of solutions, and
decreasing the constraint coefficient corresponding to the constraint upon determining that the predetermined number of solutions satisfying the constraint are included in the plurality of solutions.

7. The non-transitory computer-readable storage medium according to claim 1, wherein the process further includes
calculating, after adjusting the constraint coefficient, an energy corresponding to each of the plurality of solutions stored in the memory, based on the evaluation function including the adjusted constraint coefficient, and
replacing a worst solution among the plurality of solutions stored in the memory with a first solution newly obtained by the search, depending on a comparison between a first energy calculated for the first solution using the evaluation function and the energy corresponding to the worst solution among the plurality of solutions.

8. The non-transitory computer-readable storage medium according to claim 7, wherein the process further includes generating a search start state to be used for a next execution of the search, based on the plurality of solutions stored in the memory.

9. The non-transitory computer-readable storage medium according to claim 1, wherein the process further includes
storing, in the memory, one or more solutions that are candidates for a final output, separately from the plurality of solutions, and an output evaluation energy corresponding to each of the one or more solutions, the output evaluation energy being calculated using the evaluation function in which the constraint coefficient is set to a fixed value that remain unchanged for each execution of the search,
replacing a worst solution among the one or more solutions stored in the memory with a first solution newly obtained by the search, depending on a comparison between a first output evaluation energy calculated for the first solution using the evaluation function in which the constraint coefficient is set to the fixed value and the output evaluation energy corresponding to the worst solution among the one or more solutions, and
outputting at least one solution among the one or more solutions stored in the memory upon completion of a process of repeating the adjusting of the constraint coefficient and the search.

10. A data processing method comprising:
storing, by a processor, in a memory, a solution found based on an evaluation function, the evaluation function including a penalty function representing a constraint on a plurality of state variables and a constraint coefficient by which the penalty function is multiplied; and
adjusting, by the processor, the constraint coefficient, based on a satisfaction status of the constraint for each of a plurality of solutions stored in the memory, and starting a search for a new solution based on the evaluation function including the adjusted constraint coefficient.

11. A data processing apparatus comprising:
a memory; and
a processor coupled to the memory and the processor configured to:
store, in a memory, a solution found based on an evaluation function, the evaluation function including a penalty function representing a constraint on a plurality of state variables and a constraint coefficient by which the penalty function is multiplied;
adjust the constraint coefficient, based on a satisfaction status of the constraint for each of a plurality of solutions stored in the memory; and
start a search for a new solution based on the evaluation function including the adjusted constraint coefficient.

12. The data processing apparatus according to claim 11, wherein
the constraint is provided in plurality, the penalty function is provided in plurality, and the evaluation function includes the plurality of penalty functions corresponding to the plurality of constraints, and
the processor is further configured to adjust, for each constraint of the plurality of constraints, a constraint coefficient corresponding to said each constraint, based on a satisfaction status of said each constraint for each of the plurality of solutions.

13. The data processing apparatus according to claim 12, wherein the plurality of constraints include an equality constraint, an inequality constraint, or both the equality constraint and the inequality constraint.

14. The data processing apparatus according to claim 12, wherein
the plurality of constraints include an equality constraint and an inequality constraint, and
the processor is further configured to increase, with a predetermined probability, at least one of a first constraint coefficient corresponding to the equality constraint or a second constraint coefficient corresponding to the inequality constraint, upon determining that no solution satisfying all the equality constraint and the inequality constraint is included in the plurality of solutions.

15. The data processing apparatus according to claim 11, wherein the constraint is an equality constraint or an inequality constraint.

16. The data processing apparatus according to claim 11, wherein the processor is further configured to:
increase the constraint coefficient corresponding to the constraint upon determining that a predetermined number of solutions satisfying the constraint are not included in the plurality of solutions; and
decrease the constraint coefficient corresponding to the constraint upon determining that the predetermined number of solutions satisfying the constraint are included in the plurality of solutions.

17. The data processing apparatus according to claim 11, wherein the processor is further configured to:
calculate, after adjusting the constraint coefficient, an energy corresponding to each of the plurality of solutions stored in the memory, based on the evaluation function including the adjusted constraint coefficient; and
replace a worst solution among the plurality of solutions stored in the memory with a first solution newly obtained by the search, depending on a comparison between a first energy calculated for the first solution using the evaluation function and the energy corresponding to the worst solution among the plurality of solutions.

18. The data processing apparatus according to claim 17, wherein the processor is further configured to generate a search start state to be used for a next execution of the search, based on the plurality of solutions stored in the memory.

19. The data processing apparatus according to claim 11, wherein the processor is further configured to:
store, in the memory, one or more solutions that are candidates for a final output, separately from the plurality of solutions, and an output evaluation energy corresponding to each of the one or more solutions, the output evaluation energy being calculated using the evaluation function in which the constraint coefficient is set to a fixed value that remain unchanged for each execution of the search;
replace a worst solution among the one or more solutions stored in the memory with a first solution newly obtained by the search, depending on a comparison between a first output evaluation energy calculated for the first solution using the evaluation function in which the constraint coefficient is set to the fixed value and the output evaluation energy corresponding to the worst solution among the one or more solutions; and
output at least one solution among the one or more solutions stored in the memory upon completion of a process of repeating adjusting of the constraint coefficient and the search.
